(19) United States
(12) Patent Application Publication
(10) Pub. No.: US 2019/0205813 A1
(43) Pub. Date: Jul. 4, 2019

(54) METHOD AND SYSTEM FOR TRANSPORTATION SERVICE ROUTING

(71) Applicant: ANI TECHNOLOGIES PRIVATE LIMITED, Bengaluru (IN)

(72) Inventors: Harshit Sharma, East Vinod Nagar (IN); Rajesh Kumar Singh, Bokaro Steel City (IN)

(73) Assignee: ANI Technologies Private Limited

(21) Appl. No.: 15/935,963

(22) Filed: Mar. 26, 2018

(30) Foreign Application Priority Data
Dec. 29, 2017 (IN) 201741047374

(51) Int. Cl. G06Q 10/06; G06F 17/30

(52) U.S. Cl. CPC G06Q 10/063116; G06F 17/30864

(57) ABSTRACT

A method and system for determining transportation service routes for vehicles is provided. A transportation server receives commutation requests of commuters travelling from different pick-up locations to the same drop-off location. The pick-up locations are clustered into first and second sets of clusters based on one or more clustering parameters. The transportation server determines a plurality of route combinations for the first set of clusters. The transportation server also determines fitness-scores for each route combination. Optimum route combination is determined from the plurality of route combinations based on the fitness-scores. First and second sets of vehicles of a plurality of vehicles travel along first and second sets of routes to cater to the first and second sets of clusters.

### CROSS-RELATED APPLICATIONS

This application claims priority of Indian Application Serial No. 201741047374, filed Dec. 29, 2017, the contents of which are incorporated herein by reference.

### FIELD OF THE INVENTION

The present invention relates generally to transportation services, and more particularly, to a method and system for determining transportation service routes.

### BACKGROUND

The popularity of on-demand transportation services has increased tremendously in recent years as the transportation services can be offered quickly and conveniently to commuters. As a result, the congestion along the road networks and fuel consumption by vehicles have also increased many folds. Usage of shared vehicles has emerged as a popular solution to combat the ever-increasing congestion along the road networks and increasing fuel consumption. Consequently, commuters that travel on a daily basis prefer sharing vehicles with other commuters while travelling. A large number of commuters that travel to a same destination location periodically may opt for a transportation service that offers vehicle sharing. For example, employees of an organization that travel to their workplace every day can utilize a transportation service that provides pick-up from different locations to the workplace using the shared vehicles.

When the vehicles are shared among different commuters for travelling to the same destination, optimum transportation service routes need to be determined for proper utilization of the shared vehicles and fuel. Additionally, in many cases, such transportation services must be provided under certain constraints to provide a pleasant travel experience to the commuters. For example, when transporting the employees of an organization to their workplace, there may be a time constraint specifying a maximum travel duration for the employees so that the employees reach their workplace on time. When the commuters are picked up from different locations for travelling to the same destination, it is possible that a large distance is covered by the shared vehicle to serve each commuter. In such a case, a transportation service provider may apply a constraint specifying a maximum distance travelled by each commuter of the shared vehicle, thus ensuring a pleasant travel experience for the commuters.

Existing solutions for determining optimum transportation service routes for the transportation services are implemented at geographical coordinate level, i.e., at longitude-latitude level, which require large processing time to determine the optimum transportation service routes. Additionally, existing solutions are static and fail to provide the optimum transportation service routes for transportation services under one or more constraints.

In light of the foregoing, there exists a need for a solution that solves the abovementioned problems and provides a dynamically adaptable solution that not only requires less processing time but also takes into consideration the one or more constraints set by the transportation service providers.

### SUMMARY

In an embodiment of the present invention, a method and system for determining transportation service routes for vehicles are provided. A plurality of pick-up locations of a plurality of commuters are clustered by circuitry of the system, based on one or more clustering parameters. Each cluster includes one or more pick-up locations of the plurality of pick-up locations. Each cluster also has a corresponding cluster size. A plurality of route combinations are determined for a set of vehicles to cater to a set of clusters of the plurality of clusters, based on a vehicle capacity of each of the set of vehicles and the cluster size of each of the set of clusters. Each route combination includes a set of transportation service routes. The set of transportation service routes caters to the set of clusters and terminates at a drop-off location. A fitness-score is determined by the circuitry for each route combination based on one or more fitness parameters. An optimum route combination is selected by the circuitry from the plurality of route combinations based on the fitness-score. The set of vehicles is dispatched along the set of transportation service routes of the optimum route combination to pick-up a set of commuters of the plurality of commuters. The set of commuters is associated with the set of clusters.

Various embodiments of the present invention provide a method and a system for determining transportation service routes for vehicles. Various commutation requests are received by a transportation server from at least one of a database server or commuter-computing devices of multiple commuters. The commutation requests include pick-up locations of the commuters and a drop-off location. Based on parameters such as a distance threshold parameter and a time threshold parameter, the pick-up locations of the commuters are clustered into multiple clusters. Each cluster has a corresponding cluster size that represents a count of pick-up locations in the corresponding cluster. Multiple route combinations are determined for a set of vehicles to cater to a set of clusters, based on the cluster size of each cluster and a vehicle capacity of each of the set of vehicles. Each route combination includes one or more transportation service routes that cater to the set of clusters and terminate at the drop-off location. A fitness-score is determined for each route combination based on fitness parameters, such as a distance fitness parameter and a time fitness parameter. An optimum route combination is selected from the multiple route combinations, based on the determined fitness-scores. The set of vehicles is then dispatched along the transportation service routes of the optimum route combination for picking-up a set of commuters that is associated with the set of clusters. By using the transportation service routes of the optimum route combination for catering to the set of clusters, the set of vehicles are utilized efficiently.

The fitness-score for each route combination is determined based on the distance and time fitness parameters. The distance and time fitness parameters are dynamically adaptable to suit one or more requirements of the transportation service providers, which make the selection of the optimum route combination also dynamic. Since the determination of the route combinations is performed at cluster level rather than at geographical-coordinate level, i.e., at longitude-latitude level, the processing time required to select the optimum route combination is less in comparison to the conventional solutions.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an environment for determining transportation service routes for vehicles, in accordance with an embodiment of the present invention;

FIG. 2 is a block diagram that illustrates a transportation server of the environment of FIG. 1, in accordance with an embodiment of the present invention;

FIGS. 3A and 3B are exemplary scenarios that illustrate clustering of a plurality of pick-up locations, in accordance with an embodiment of the present invention;

FIG. 4 is an exemplary scenario that illustrates an assignment of vehicles to clusters, in accordance with an embodiment of the present invention;

FIGS. 5A and 5B, collectively, represent a flow chart that illustrates a method for determining a route combination for a second set of vehicles to cater to a second of clusters, in accordance with an embodiment of the present invention;

FIG. 6 is a block diagram that illustrates an exemplary route combination of FIGS. 5A and 5B, in accordance with an embodiment of the present invention;

FIG. 7 is a flow chart that illustrates a method for selecting an optimum route combination from a plurality of route combinations, in accordance with an embodiment of the present invention;

FIGS. 8A and 8B are exemplary scenarios that illustrate mutation and crossover operations, respectively, in accordance with an embodiment of the present invention;

FIG. 9 is an exemplary scenario that illustrates dispatching vehicles along a first set of routes and a second set of routes included in the optimum route combination, in accordance with an embodiment of the present invention;

FIGS. 10A and 10B, collectively, represent a flow chart that illustrates a method for determining routes for vehicles, in accordance with an embodiment of the present invention; and

FIG. 11 illustrates a block diagram of a computer system for determining transportation service routes for vehicles in the environment of FIG. 1, in accordance with an embodiment of the present invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes a system for determining transportation service routes for vehicles. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

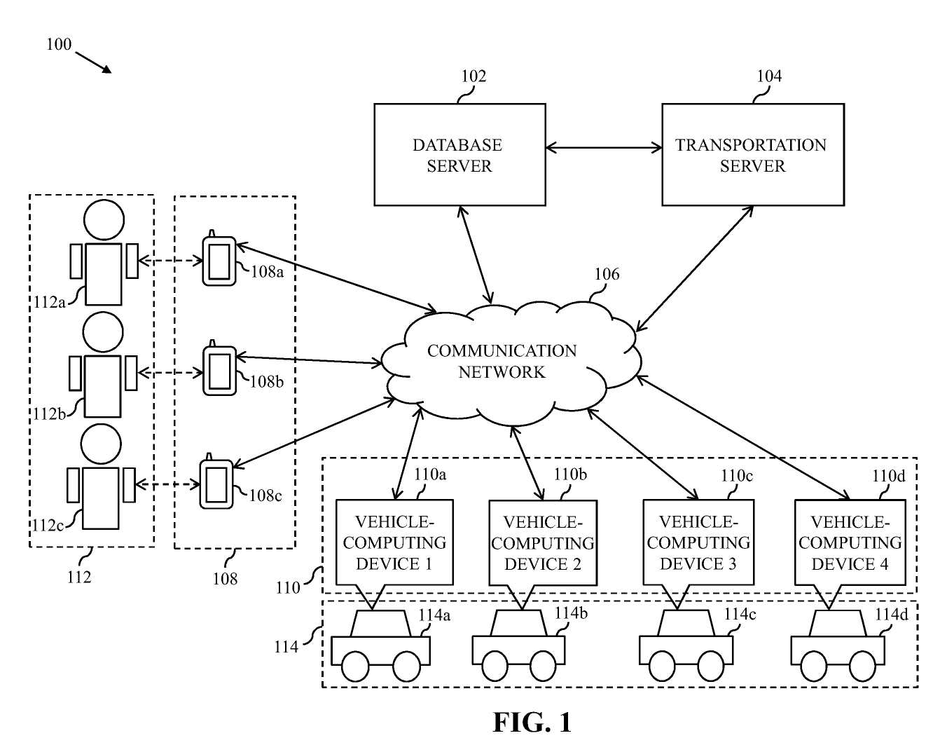

Referring now to FIG. 1, a block diagram that illustrates an environment 100 for determining transportation service routes (hereinafter referred to as “routes”) for vehicles, in accordance with an embodiment of the present invention, is shown. The environment 100 includes a database server 102 and a transportation server 104 associated with a transportation service provider (not shown). The database server 102 and the transportation server 104 communicate by way of a communication network 106. The environment 100 further includes commuter-computing devices 108 and vehicle-computing devices 110. The commuter-computing devices 108 include first through third commuter-computing devices 108a-108c and the vehicle-computing devices 110 include first through fourth vehicle-computing devices 110a-110d. The commuter-computing devices 108 are associated with commuters 112. For example, the first through third commuter-computing devices 108a-108c are associated with first through third commuters 112a-112c (i.e., the commuters 112), respectively. The vehicle-computing devices 110 are associated with vehicles 114. For example, the first through fourth vehicle-computing devices 110a-110d are associated with first through fourth vehicles 114a-114d (i.e., the vehicles 114), respectively. FIG. 1 shows, for simplicity, three commuter-computing devices and four vehicle-computing devices. However, it will be apparent to a person having ordinary skill in the art that the disclosed embodiments may be implemented by using multiple commuter-computing devices and multiple vehicle-computing devices, without departing from the spirit of the invention.

The database server 102 is a data management and storage server that is communicatively coupled to the communication network 106. The database server 102 performs one or more database operations, such as receiving, storing, processing, and transmitting queries, data, or content. The queries, data, or content is received/transmitted from/to various components of the environment 100. The database server 102 includes a processor (not shown) and a memory (not shown) for managing and storing travel data of the commuters 112. The travel data of the commuters 112 includes location information pertaining to various locations that are traveled by the commuters 112. For example, the travel data of the first commuter 112a includes location information pertaining to the locations traveled by the first commuter 112a. The database server 102 further stores commutation requests of the commuters 112. The database server 102 receives the commutation requests of the commuters 112 from the corresponding commuter-computing devices 108.The commutation requests include a plurality of pick-up locations and a drop-off location of the commuters 112. In one embodiment, one pick-up location may be associated with one commutation request. In another embodiment, one pick-up location may be associated with multiple commutation requests. In one example, each pick-up location and the drop-off location is represented by a unique combination of latitude and longitude coordinates. Each commutation request further includes a time-stamp that indicates a time instance at which the corresponding commutation request was raised. The database server 102 further stores commuter profiles of the commuters 112. For example, a commuter profile of the first commuter 112a includes details, such as name, age, work place address, home address, gender, contact information, or the like of the first commuter 112a. In an embodiment, the database server 102 may receive a query from the transportation server 104 over the communication network 106, to retrieve the travel data, the commutation requests, the commuter profiles, or the like. The database server 102, in response to the received query from the transportation server 104, transmits the requested information to the transportation server 104. Examples of the database server 102 include, but are not limited to, a personal computer, a laptop, or a network of computer systems.

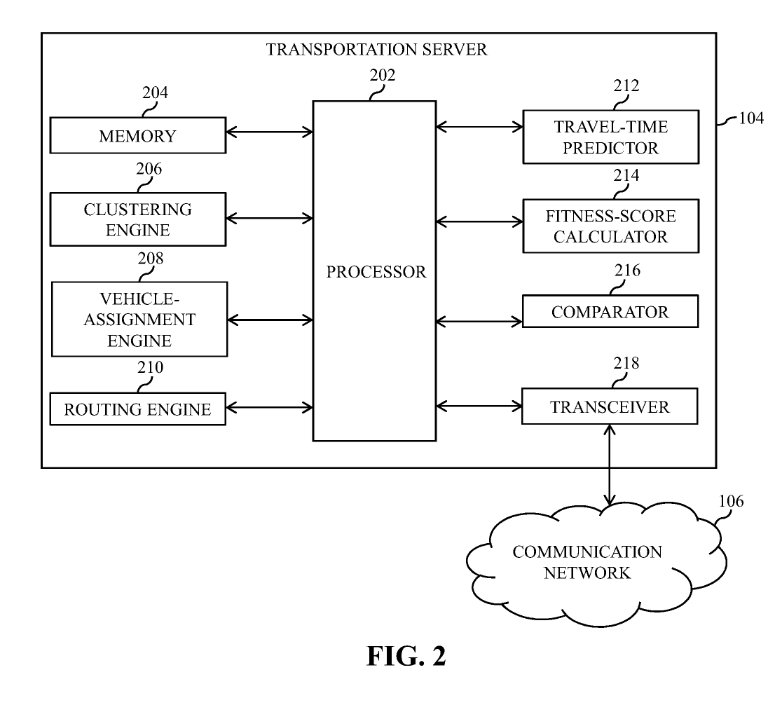

The transportation server 104 is an electronic device, a computing device, a software framework, or a combination thereof, hosting an application or a software service. The transportation server 104 is communicatively coupled to the communication network 106. In one embodiment, the operation of the transportation server 104 may be dedicated to execution of procedures, such as, but are not limited to, programs, routines, or scripts stored in memories for supporting its applied applications. The transportation server 104 receives the commutation requests from the database server 102 and/or the commuter-computing devices 108, over the communication network 106. The transportation server 104 determines a plurality of route combinations for the vehicles 114 to serve the commutation requests. Each route combination includes a set of routes. The transportation server 104 then selects an optimum route combination from the plurality of route combinations to serve the commutation requests. The transportation server 104 further transmits a route notification regarding the pick-up locations of the commuters 112 and the set of routes to each of the vehicle-computing devices 110 by way of the communication network 106. Based on the route notifications, the vehicles 114 are dispatched along the set of routes. The transportation server 104 may be realized through various web-based technologies such as, but not limited to, a Java web-framework, a .NET framework, a PHP framework, or any other web-application framework. Examples of the transportation server 104 include, but are not limited to, a personal computer, a laptop, or a network of computer systems. The elements of the transportation server 104 have been described in detail in conjunction with FIG. 2.

It will be apparent to a person having ordinary skill in the art that the scope of the invention is not limited to realizing the database server 102 and the transportation server 104 as separate entities. In an embodiment, the functionalities of the database server 102 can be integrated into the transportation server 104, without departing from the spirit of the invention. Further, in an embodiment, the transportation server 104 may be realized as an application program installed on and/or running on the vehicle-computing devices 110 and/or the commuter-computing devices 108, without departing from the spirit of the invention.

The communication network 106 is a medium through which content and messages are transmitted between various devices, such as the database server 102, the transportation server 104, the commuter-computing devices 108, and the vehicle-computing devices 110. Examples of the communication network 106 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a mobile network such as cellular data, high speed packet access (HSPA), or any combination thereof. Various devices in the environment 100 may connect to the communication network 106 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G) communication protocols, Long Term Evolution (LTE) communication protocols, or any combination thereof.

The commuter-computing devices 108 are computing devices that are communicatively coupled to the communication network 106. The commuters 112 utilize the corresponding commuter-computing devices 108 to perform one or more activities. For example, the first commuter 112a utilizes the first commuter-computing device 108a to raise a commutation request for travelling between a first pick-up location and the drop-off location. The commuter-computing devices 108 transmit the commutation requests to the transportation server 104. In one embodiment, each of the commuter-computing devices 108 includes a navigation sensor, such as a global positioning system (GPS), for tracking a real-time location of the corresponding commuter-computing device. The commuter-computing devices 108 further transmit the tracked real-time locations to the database server 102 and the transportation server 104. In one embodiment, each of the commuter-computing devices 108 may have a service application installed in it. The commuters 112 utilize the corresponding service application to raise the commutation requests. For raising a commutation request to travel, a commuter (for example, the first commuter 112a) inputs details pertaining to the travel by way of the service application. The details include a pick-up location, a drop-off location, a time of travel, or the like. In one scenario, the pick-up location may be the current location of the first commuter 112a. In such a scenario, the first commuter-computing device 108a tracks the current location and automatically enters the pick-up location in the commutation request. In another scenario, the pick-up location may not be the current location of the first commuter 112a. In such a case, the first commuter 112a manually inputs the pick-up location by way of the service application. In yet another embodiment, the service application automatically detects the pick-up location and the drop-off location of the first commuter 112a based on the historical travel data of the first commuter 112a. For example, the first commuter 112a travels from his/her home to work-place at 9:00 AM on weekdays. Hence, when the first commuter 112a raises a commutation request at 8:30 AM on a weekday, the service application automatically detects the pick-up location and the drop-off location as the home and work-place, respectively, of the first commuter 112a. In an alternate embodiment, when the commuters 112 are employees of an organization, the pick-up locations and the drop-off location may be provided by an employer (not shown) of the commuters 112. For example, the employer may save the pick-up location and the drop-off location of the commuters 112 in the corresponding commuter profiles that are stored in the database server 102. In such a scenario, the service application may transmit the commutation request without including the pick-up and drop-off locations. The pick-up and drop-off locations as provided by the employer may be retrieved from the database server 102. In yet another embodiment, the employer may raise the commutation requests on behalf of the commuters 112 by specifying the corresponding pick-up locations and the drop-off locations of the commuters 112. Examples of the commuter-computing devices 108 include, but are not limited to, a mobile phone, a smartphone, a personal digital assistant (PDA), a tablet, a phablet, a laptop, or any other portable communication device.

The vehicle-computing devices 110 are computing devices that are communicatively coupled to the communication network 106. The vehicle-computing devices 110 are installed within the vehicles 114. For example, the first vehicle-computing device 110a is installed within the first vehicle 114a. The vehicles 114 are means of transport that are deployed by the transportation service provider to provide transportation services to the commuters 112. Examples of the vehicles 114 include an automobile, a bus, a car, a bike, or the like. Each of the vehicles 114 may be associated with a driver (not shown). The commuters 112 may travel in the vehicles 114 from their corresponding pick-up locations to the drop-off location. Each of the vehicles 114 has a vehicle capacity that indicates a maximum count of commuters that can travel in the corresponding vehicle at a time instance. For example, the first vehicle 114a has a vehicle capacity of four. Thus, at any time instance a maximum of four commuters can travel in the first vehicle 114a. In one embodiment, the vehicle capacity of each of the vehicles 114 is same. In another embodiment, the vehicle capacity of each of the vehicles 114 may be different. Each of the vehicle-computing devices 110 receives the route notification from the transportation server 104 indicating a route to be followed by the corresponding vehicle. In one embodiment, each of the vehicle-computing devices 110 may have a service application installed in it. Each service application presents the corresponding route notification to the drivers of the vehicles 114 for picking-up the commuters 112 from their corresponding pick-up locations. In one example, the vehicle-computing devices 110 are vehicle head-units of the corresponding vehicle. In another example, the vehicle-computing devices 110 are external communication devices, such as a mobile phone, a smartphone, a tablet, a phablet, or any other portable communication device, which are placed inside the corresponding vehicle.

Referring now to FIG. 2, a block diagram that illustrates the transportation server 104 of the environment 100, in accordance with an embodiment of the present invention, is shown. The transportation server 104 includes a processor 202, a memory 204, a clustering engine 206, a vehicle-assignment engine 208, a routing engine 210, a travel-time predictor 212, a fitness-score calculator 214, a comparator 216, and a transceiver 218.

The processor 202 includes suitable logic, circuitry, and/or interfaces that are operable to execute instructions, programs, codes, and/or scripts stored in the memory 204 to perform one or more operations. For example, the processor 202 receives the commutation requests from the database server 102. In another embodiment, the processor 202 receives the commutation requests from the commuter-computing devices 108. The processor 202 stores the commutation requests in the memory 204. It will be apparent to a person skilled in the art that the processor 202 is compatible with multiple operating systems.

The memory 204 includes suitable logic, circuitry, and/or interfaces to store the commutation requests of the commuters 112. The memory 204 may also store machine codes, or computer programs executable by the processor 202. Examples of the memory 204 include, but are not limited to, a random access memory (RAM), a read-only memory (ROM), a programmable ROM (PROM), an erasable PROM (EPROM), a hard disk drive (HDD), and a secure digital (SD) card and the like.

The clustering engine 206 may comprise suitable logic, circuitry, interfaces, and/or code that may be operable to execute one or more sets of instructions, codes, scripts, and programs stored in the memory 204. The clustering engine 206 clusters the pick-up locations included in the commutation requests into a plurality of clusters. Each cluster has a corresponding cluster size. The cluster size of a cluster indicates a count of pick-up locations in the cluster. Since each pick-up location is associated with one commutation request, the cluster size may also indicate a count of commutation requests that the cluster is associated with. For example, if five pick-up locations, each associated with a commutation request of a commuter, are clustered into a cluster, the cluster has a cluster size of five. The clustering engine 206 may be realized by implementing one or more mathematical models, one or more statistical models, and/or one or more algorithms.

The vehicle-assignment engine 208 may comprise suitable logic, circuitry, interfaces, and/or code that may be operable to execute one or more sets of instructions, codes, scripts, and programs stored in the memory 204. The vehicle-assignment engine 208 assigns a first set of vehicles from the vehicles 114 to a first set of clusters from the plurality of clusters. In an embodiment, the vehicle-assignment engine 208 may assign the first set of vehicles to the first set of clusters based on the vehicle capacity of each vehicle in the first set of vehicles and the cluster size of each cluster in the first set of clusters. The vehicle-assignment engine 208 may be realized by implementing one or more mathematical models, one or more statistical models and/or one or more algorithms.

The routing engine 210 may comprise suitable logic, circuitry, interfaces, and/or code that may be operable to execute one or more sets of instructions, codes, scripts, and programs stored in the memory 204. The routing engine 210 determines the plurality of route combinations, each including the corresponding set of routes, for the vehicles 114 to cater to the plurality of clusters. The routing engine 210 may determine the plurality of route combinations based on the vehicle capacity of each vehicle and the cluster size of each cluster. The routing engine 210 may be realized by use of one or more mathematical models, one or more statistical models and/or one or more algorithms.

The travel-time predictor 212 may comprise suitable logic, circuitry, interfaces, and/or code that may be operable to execute one or more sets of instructions, codes, scripts, and programs stored in the memory 204. The travel-time predictor 212 predicts a travel duration for travelling from one cluster to another cluster. In one embodiment, the travel-time predictor 212 further determines a travel duration associated with each route of the plurality of route combinations, based on the predicted travel duration for travelling from one cluster to another cluster. The travel-time predictor 212 may be realized by implementing one or more mathematical models, one or more statistical models and/or one or more algorithms.

The fitness-score calculator 214 may comprise suitable logic, circuitry, interfaces, and/or code that may be operable to execute one or more sets of instructions, codes, scripts, and programs stored in the memory 204. The fitness-score calculator 214 calculates fitness-scores for the plurality of route combinations. A fitness-score is a quality meter that is used to compare the plurality of route combinations. For example, a route combination having a higher fitness-score is considered optimum as compared to another route combination having a low fitness-score. The fitness-score calculator 214 may be realized by implementing one or more mathematical models, one or more statistical models and/or one or more algorithms.

The comparator 216 may comprise suitable logic, circuitry, interfaces, and/or code that may be operable to execute one or more sets of instructions, codes, scripts, and programs stored in the memory 204. The comparator 216 compares the plurality of route combinations based on the fitness-scores. Based on the comparison performed by the comparator 216, the processor 202 selects the optimum route combination from the plurality of route combinations. The comparator 216 may be realized by use of one or more mathematical models, one or more statistical models and/or one or more algorithms.

The processor 202, the clustering engine 206, the vehicle-assignment engine 208, the routing engine 210, the travel-time predictor 212, the fitness-score calculator 214, and the comparator 216 are realized through various electronic components such as, but not limited to, a system on chip (SoC) component, an application-specific integrated circuit (ASIC) processor, a reduced instruction set computing (RISC) processor, a complex instruction set computing (CISC) processor, or a field-programmable gate array (FPGA) processor.

Though, the clustering engine 206, the vehicle-assignment engine 208, the routing engine 210, the travel-time predictor 212, the fitness-score calculator 214, and the comparator 216 are depicted as separate entities in FIG. 2, a person skilled in the art will appreciate that they may be implemented within the processor 202 without departing from the spirit of the invention. Further, a person skilled in the art will appreciate that the processor 202 may be configured to perform the functionalities of the clustering engine 206, the vehicle-assignment engine 208, the routing engine 210, the travel-time predictor 212, the fitness-score calculator 214, and the comparator 216, without departing from the spirit of the invention.

The transceiver 218 includes suitable logic, circuitry, and/or interfaces to transmit or receive messages from various devices, such as the database server 102, the commuter-computing devices 108, and the vehicle-computing devices 110. The transceiver 218 communicates with the database server 102, the commuter-computing devices 108, and the vehicle-computing devices 110, over the communication network 106. In one example, the transceiver 218 receives the commutation requests from the database server 102. In another example, the transceiver 218 receives the commutation requests from the commuter-computing devices 108. Examples of the transceiver 218 include, but are not limited to, an antenna, a radio frequency transceiver, a wireless transceiver, and the like. The transceiver 218 communicates with the database server 102, the commuter-computing devices 108, and the vehicle-computing devices 110 using various wired and wireless communication protocols, such as TCP/IP, UDP, 2nd Generation (2G), 3rd Generation (3G), 4th Generation (4G) communication protocols, or any combination thereof.

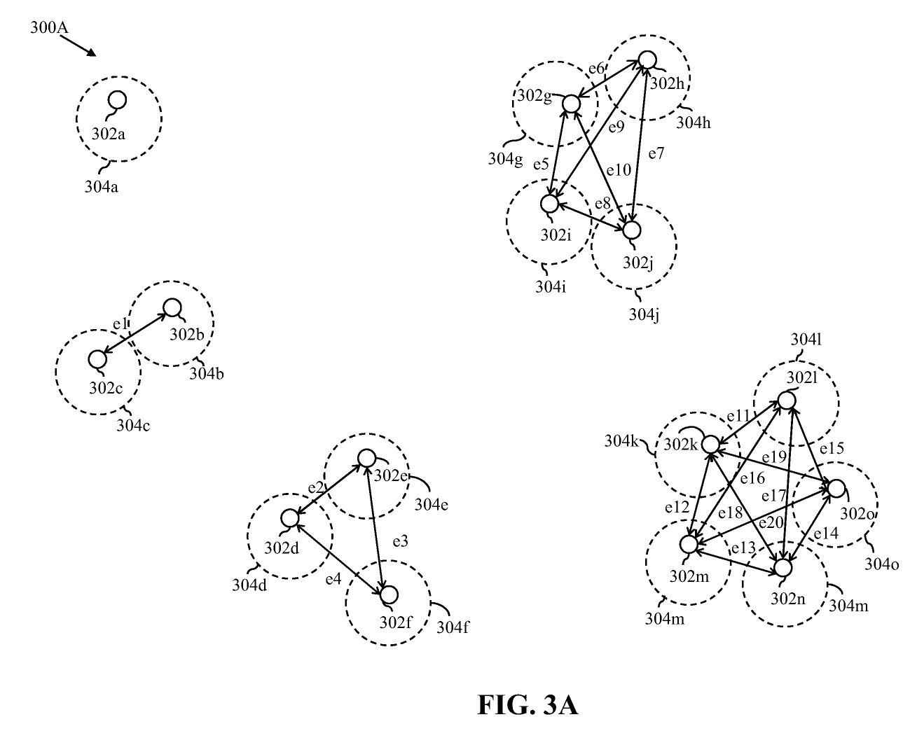

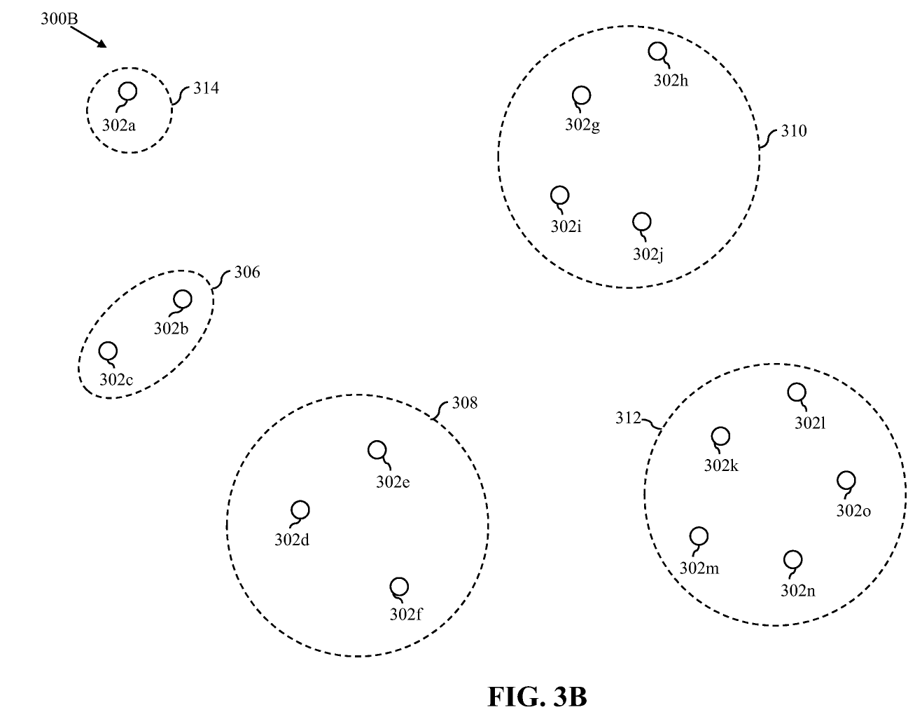

Functioning of the processor 202, the memory 204, the clustering engine 206, the vehicle-assignment engine 208, the routing engine 210, the travel-time predictor 212, the fitness-score calculator 214, the comparator 216, and the transceiver 218 is explained in detail in conjunction with FIGS. 3A and 3B, FIGS. 4, and 5A and 5B.

Referring now to FIGS. 3A and 3B, exemplary scenarios 300A and 300B that illustrate clustering of a plurality of pick-up locations, in accordance with an embodiment of the present invention, are shown.

With reference to FIG. 3A, the exemplary scenario 300A illustrates first through fifteenth pick-up locations 302a-302o (i.e., the plurality of pick-up locations). For the sake of simplicity, the exemplary scenario 300A is shown to include fifteen pick-up locations. However, it will be apparent to a person skilled in the art that the plurality of pick-up locations may include any number of pick-up locations.

In one embodiment, the processor 202 retrieves the travel data of fifteen commuters (not shown) from the database server 102. The travel data includes information pertaining to the first through fifteenth pick-up locations 302a-302o. Each pick-up location is associated with one commuter. In one example, the fifteen commuters may have raised fifteen commutation requests to travel from the first through fifteenth pick-up locations 302a-302o to the drop-off location, in past. In another embodiment, the transceiver 218 receives the fifteen commutation requests from commuter-computing devices of the fifteen commuters, respectively, in real-time. In yet another embodiment, when the fifteen commuters are employees of an organization, the employer of the fifteen commuters may raise the fifteen commutation requests including the first through fifteenth pick-up locations 302a-302o and the drop-off location on behalf of the fifteen commuters. The transceiver 218 thus receives the fifteen commutation requests including the information pertaining to the first through fifteenth pick-up locations 302a-302o from an employer-computing device (not shown).

The clustering engine 206 receives the information pertaining to the first through fifteenth pick-up locations 302a-302o from the processor 202. The clustering engine 206 clusters the first through fifteenth pick-up locations 302a-302o based on clustering parameters. The clustering parameters include distance and travel-time threshold parameters. In one example, the clustering engine 206 executes single-linkage clustering for clustering the first through fifteenth pick-up locations 302a-302o. The exemplary scenario 300A represents an initial stage of the single-linkage clustering.

At the initial stage, the clustering engine 206 represents each pick-up location of the first through fifteenth pick-up locations 302a-302o as one intermediate cluster. For example, the first through fifteenth pick-up locations 302a-302o represent first through fifteenth intermediate clusters 304a-304o, respectively. The clustering engine 206 then determines a distance of each intermediate cluster from other intermediate clusters. For example, a distance between the first intermediate cluster 304a and the second intermediate cluster 304b is 1 kilometer (km). The travel-time predictor 212 determines travel duration for travelling from each intermediate cluster to other intermediate clusters. For example, travel duration for travelling from the first intermediate cluster 304a to the second intermediate cluster 304b is 15 minutes.

Based on the determined distances and travel durations, the clustering engine 206 connects one or more intermediate clusters of the first through fifteenth intermediate clusters 304a-304o. In one embodiment, the clustering engine 206 connects an intermediate cluster with another intermediate cluster, when the distance between the intermediate cluster and the other intermediate cluster is less than or equal to the distance threshold parameter and when the travel duration for travelling from the intermediate cluster to the other intermediate cluster is less than or equal to the travel-time threshold parameter. Since, the first through fifteenth intermediate clusters 304a-304o represent the first through fifteenth pick-up locations 302a-302o, respectively, the clustering engine 206 indirectly connects a pick-up location with another pick-up location based on the distance and travel-time threshold parameters at the initial stage. For example, the second intermediate cluster 304b is connected to the third intermediate cluster 304c by way of a first edge e1. Similarly, the remaining intermediate clusters that satisfy the distance and travel-time threshold parameters are also connected by way of second through twentieth edges e2-e20. In one scenario, when an intermediate cluster is not reachable from any other intermediate cluster within the distance threshold parameter, the intermediate cluster remains unconnected. When an intermediate cluster is not reachable from any other intermediate cluster within the travel-time threshold parameter, the intermediate cluster remains unconnected. For example, the first intermediate cluster 304a is not connected to any other intermediate cluster as the clustering engine 206 determines that the distance and travel-time threshold parameters are not satisfied by the first intermediate cluster 304a.

In one embodiment, the one or more clustering parameters are provided by the transportation service provider. The transportation service provider may further update the one or more clustering parameters. Thus, based on the update in the one or more clustering parameters, the clustering engine 206 may update the connections among the first through fifteenth intermediate clusters 304a-304o.

With reference to FIG. 3B, the exemplary scenario 300B illustrates a final stage of the single-linkage clustering. At the final stage, the clustering engine 206 merges two or more intermediate clusters based on the connections. For example, the clustering engine 206 merges the second and third intermediate clusters 304b and 304c (of FIG. 3A) to form a first cluster 306. Similarly, the clustering engine 206 merges the fourth through sixth intermediate clusters 304d-304f (of FIG. 3A) to form a second cluster 308. Further, the seventh through tenth intermediate clusters 304g-304j (of FIG. 3A) are merged to form a third cluster 310 and the eleventh through fifteenth intermediate clusters 304k-304o (of FIG. 3A) are merged to form a fourth cluster 312. Since, the first intermediate cluster 304a (of FIG. 3A) is unconnected, the clustering engine 206 does not merge it with any other intermediate cluster. Thus, the first intermediate cluster 304a forms a fifth cluster 314. Hereinafter, the first through fifth clusters 306-314 are collectively referred to as “clusters 306-314”. The clusters 306-314 have cluster sizes 2, 3, 4, 5, and 1, respectively.

It will be apparent to a person skilled in the art that the abovementioned exemplary scenarios 300A and 300B are for illustrative purpose and should not be construed to limit the scope of the invention. In another embodiment, the clustering engine 206 may cluster any number of pick-up locations into any number of clusters having different cluster sizes. Based on the update in the one or more clustering parameters, the clustering engine 206 updates the clusters 306-314.

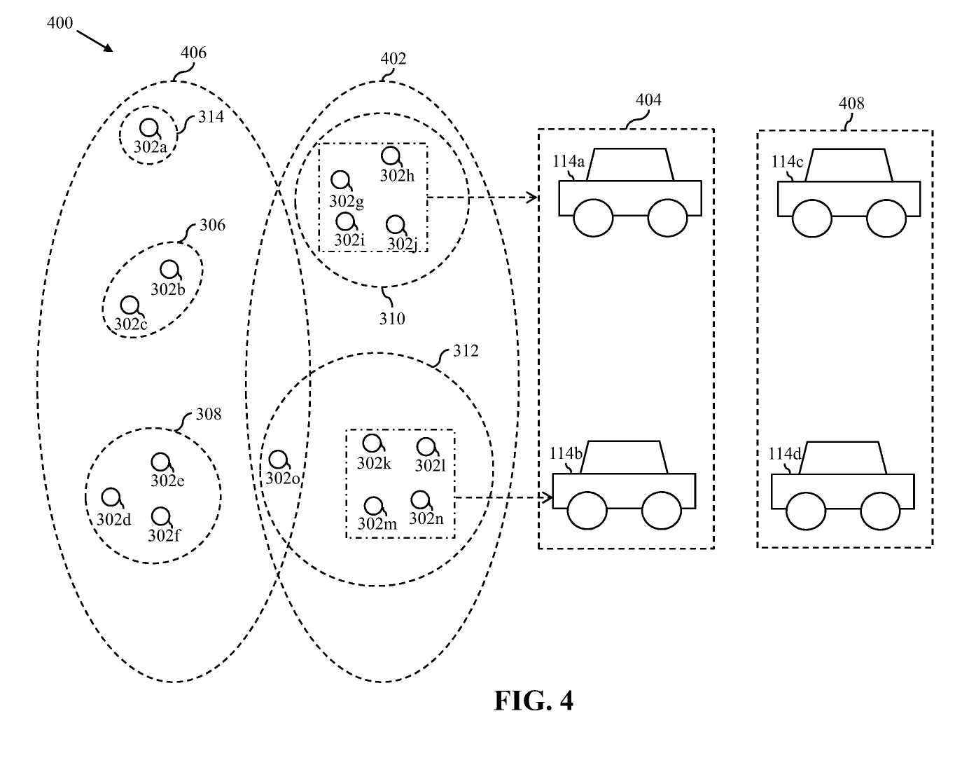

Referring now to FIG. 4, an exemplary scenario 400 that illustrates an assignment of the vehicles 114 to the clusters 306-314, in accordance with an embodiment of the present invention, is shown.

Based on the vehicle capacity of each of the vehicles 114 and the cluster size of each the clusters 306-314, the vehicle-assignment engine 208 assigns vehicles from the vehicles 114 to clusters from the clusters 306-314. The vehicle-assignment engine 208 assigns a vehicle to a cluster, when a vehicle capacity of the vehicle is less than or equal to a cluster size of the cluster. For example, as the vehicle capacity (i.e., four) of the first vehicle 114a is equal to the cluster size (i.e., four) of the third cluster 310, the vehicle-assignment engine 208 assigns the first vehicle 114a to the third cluster 310. As the vehicle capacity (i.e., four) of the second vehicle 114b is less than the cluster size (i.e., five) of the fourth cluster 312, the vehicle-assignment engine 208 assigns the second vehicle 114b to the fourth cluster 312.

The vehicle-assignment engine 208 includes the clusters that have been assigned with vehicles into a first set of clusters 402 and the corresponding assigned vehicles into a first set of vehicles 404. Thus, the third and fourth clusters 310 and 312 are included in the first set of clusters 402, and the first and second vehicles 114a and 114b are included in the first set of vehicles 404. The first set of vehicles 404 caters to the first set of clusters 402. The routing engine 210 determines a first set of routes for the first set of vehicles 404 to cater to the first set of clusters 402. Thus, the first set of routes starts from the first set of clusters 402 and terminates at the drop-off location. In one embodiment, the first set of routes includes a count of routes that is equal to a count of clusters in the first set of clusters 402. Further, each route in the first set of routes starts from one of the cluster in the first set of clusters 402 and terminates at the drop-off location.

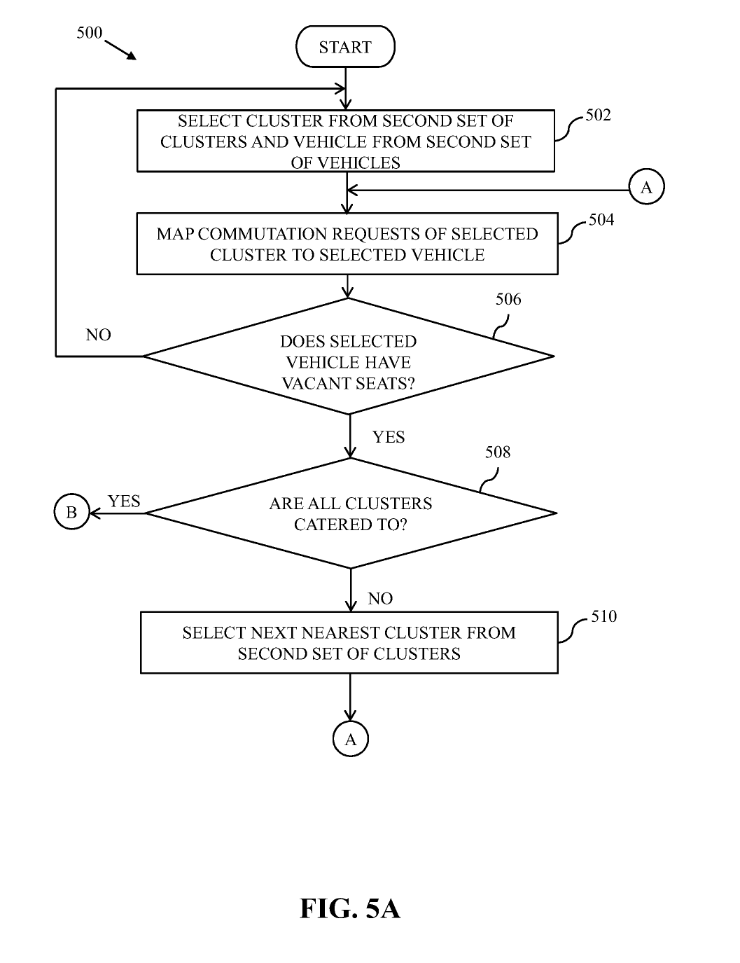

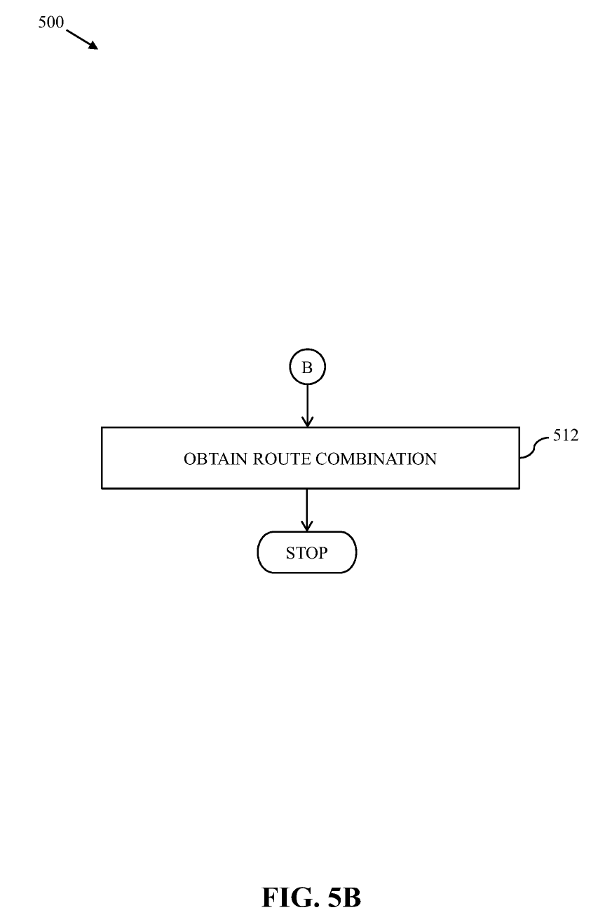

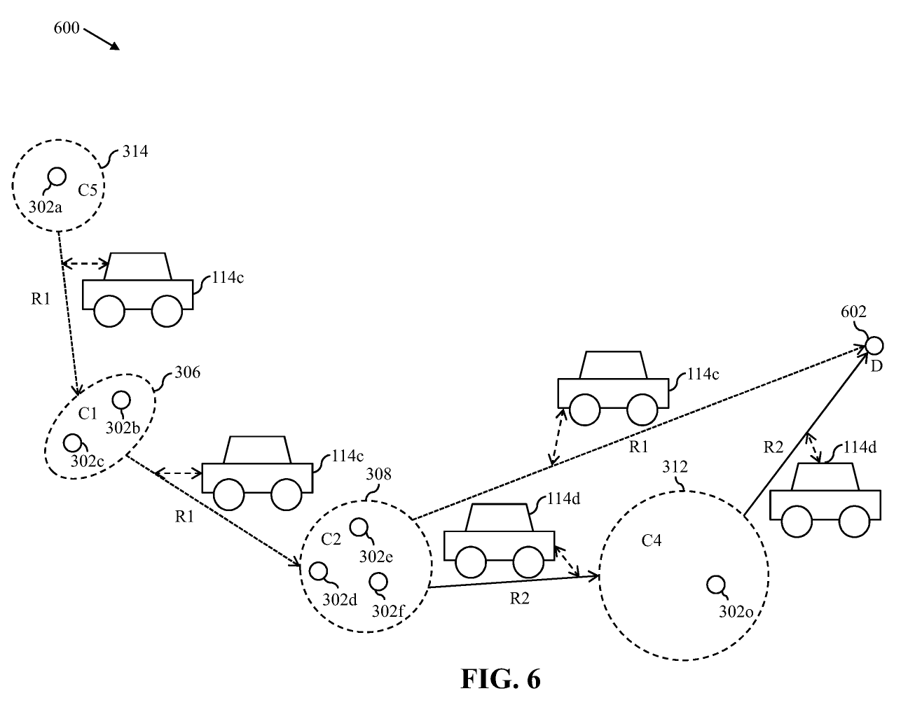

The first, second, and fifth clusters 306, 308, and 314 have cluster sizes of two, three, and one, respectively, (i.e., less than the vehicle capacity of any of the vehicles 114). Hence, the vehicle-assignment engine 208 does not assign any vehicle to the first, second, and fifth clusters 306, 308, and 314. The first, second, and fifth clusters 306, 308, and 314 that are not assigned with any vehicles by the vehicle-assignment engine 208 represent a second set of clusters 406 and unassigned vehicles are represented as a second set of vehicles 408. The second set of clusters 406 further includes a subset of the first set of clusters 402 that have the cluster size greater than the vehicle capacity of the assigned vehicle. Since, the cluster size of the fourth cluster 312 is greater than the vehicle capacity of the second vehicle 114b (i.e., the assigned vehicle), the second vehicle 114b fails to serve all the commutation requests associated with the fourth cluster 312. For example, the route for the second vehicle 114b starts from the fourth cluster 312. The second vehicle 114b visits the eleventh through fourteenth locations 302k-302n to pick-up commuters from the eleventh through fourteenth locations 302k-302n. Since the vehicle capacity of the second vehicle 114b is four, after picking-up four commuters from the eleventh through fourteenth locations 302k-302n, the second vehicle 114b has no capacity to accommodate any more commuters. Thus, the second vehicle 114b, assigned to the fourth cluster 312, fails to serve the commutation request of the commuter associated with the fifteenth location 302o. Hence, the fourth cluster 312 is also included in the second set of clusters 406. Alternatively stated, the clusters from the first set of clusters 402 for which the corresponding assigned vehicle fails to serve all of the commutation requests are also included in the second set of clusters 406. Determination of a route combination for the second set of vehicles 408 to cater to the second set of clusters 406 is explained in detail in conjunction with FIGS. 5A and 5B, and 6.

Referring now to FIGS. 5A and 5B, a flow chart 500 that illustrates a method for determining a route combination for the second set of vehicles 408 to cater to the second set of clusters 406, in accordance with an embodiment of the present invention, is shown.

At step 502, the routing engine 210 selects a cluster from the second set of clusters 406, (for example, the fifth cluster 314) and a vehicle from the second set of vehicles 408, (for example, the third vehicle 114c). The initial selection of the cluster and the vehicle is performed randomly by the routing engine 210. At step 504, the routing engine 210 maps the commutation requests of the selected cluster to the selected vehicle. For example, the routing engine 210 selects the fifth cluster 314 and the third vehicle 114c. Thus, the routing engine 210 maps the commutation request associated with the first pick-up location 302a of the fifth cluster 314 to the third vehicle 114c.

At step 506, the routing engine 210 determines whether the selected vehicle has any vacant seat. For example, the routing engine 210 determines that the third vehicle 114c has the vehicle capacity of four and can accommodate a maximum of four commuters. Thus, after the mapping of the commutation request associated with the first pick-up location 302a, the third vehicle 114c has three vacant seats. In one scenario, the third vehicle 114c may have the vehicle capacity of one and can accommodate a maximum of one commuter. In such a scenario, after the mapping of the commutation request associated with the first pick-up location 302a, the third vehicle 114c has no more vacant seats. If at step 506 it is determined that the selected vehicle does not have vacant seats, the routing engine 210 determines a first route of the route combination, and performs step 502 by selecting a next cluster (for example, the first cluster 306) from the second set of clusters 406 and a next vehicle (for example, the fourth vehicle 114d) from the second set of vehicles 408. The first route of the route combination caters to the selected cluster(s) (for example, the fifth cluster 314) and terminates at the drop-off location. If at step 506, it is determined that the selected vehicle has vacant seats, step 508 is performed.

At step 508, the routing engine 210 determines whether all clusters of the second set of clusters 406 are catered to. If at step 508, it is determined that all clusters of the second set of clusters 406 are not catered to, step 510 is performed. At step 510, the routing engine 210 selects a next cluster from the second set of clusters 406, which is nearest to the previously selected cluster and has commutation requests that are not served, and performs step 504. For example, if the routing engine 210 determines that all clusters of the second set of clusters 406 are not catered to, the routing engine 210 selects the first cluster 306 which is nearest to the fifth cluster 314 from the second set of clusters 406 and performs step 504.

If at step 508, it is determined that all clusters of the second set of clusters 406 are catered to, step 512 is performed. At step 512, the routing engine 210 determines the route combination for the second set of vehicles 408. The route combination includes a second set of routes (such as the first route) that is determined by performing the method as explained in the foregoing. The second set of routes caters to the second set of clusters 406 and terminates at the drop-off location. Thus, based on the determined route combination, the second set of vehicles 408 serve the commutation requests of the second set of clusters 406.

In one embodiment, the routing engine 210 repeats the method of the flow chart 500 multiple times by selecting different clusters and vehicles to obtain the plurality of route combinations. An exemplary route combination determined by performing the method illustrated by flow chart 500 is described in FIG. 6. In one embodiment, the routing engine 210 may fail to determine the plurality of route combinations that cater to all of the second set of clusters 406 based on one or more constraints such as distance and travel-time constraints. In such a scenario, the processor 202 determines another plurality of route combinations for the clusters that are not yet catered to by the previous plurality of route combinations. For example, the transportation service provider may have specified that the distance constraint is 4 km and the routing engine 210 fails to determine the plurality of route combinations that not only satisfy the distance constraint of 4 km but also cater to the first and second clusters 306 and 308. Thus, the routing engine 210 determines a new plurality of route combinations for the first and second clusters 306 and 308 that may or may not satisfy the distance constraint.

Referring now to FIG. 6, a block diagram 600 that illustrates an exemplary route combination of FIGS. 5A and 5B, in accordance with an embodiment of the present invention, is shown. The block diagram 600 depicts a first route combination RC1 including first and second routes R1 and R2. The first route R1 is represented by way of dotted arrows in the block diagram 600 and the second route R2 is represented by solid arrows. The first, second, fourth, and fifth clusters 306, 308, 312, and 314 are represented as C1, C2, C4, and C5, respectively. The first and second routes R1 and R2 terminate at a drop-off location ‘D’ 602. The second set of vehicles 408 (of FIG. 4) travels along the first route combination RC1 to cater to the second set of clusters 406 (of FIG. 4).

The routing engine 210 selects the fifth cluster 314 and the third vehicle 114c, and maps the commutation requests of the fifth cluster 314 to the third vehicle 114c. Since the vehicle capacity of the third vehicle 114c is four, the routing engine 210 determines that after mapping the one commutation request of the fifth cluster 314 to the third vehicle 114c, the third vehicle 114c has three vacant seats. Thus, the routing engine 210 further selects the first cluster 306 and maps the commutation requests of the first cluster 306 to the third vehicle 114c. The routing engine 210 determines that after mapping the two commutation requests of the first cluster 306 to the third vehicle 114c, the third vehicle 114c has one vacant seat left. Thus the routing engine 210 selects the second cluster 308 and maps one commutation request from the three commutation requests of the second cluster 308 to the third vehicle 114c. After mapping the one commutation request of the second cluster 308 to the third vehicle 114c, the routing engine 210 determines that the third vehicle 114c has no vacant seat left. Thus, the routing engine 210 determines the first route R1 for the third vehicle 114c. The first route R1 starts from the fifth cluster 314 and terminates at the drop-off location 602. The first route R1 includes the first and second clusters 306 and 308 as intermediate stops. In other words, the third vehicle 114c caters to the first, second, and fifth clusters 306, 308, and 314 of the first route R1.

The routing engine 210 further selects a next cluster, such as the second cluster 308, which has commutation requests that are not yet served, and a next vehicle, such as the fourth vehicle 114d, that is not yet mapped. The routing engine 210 maps the two remaining commutation requests of the second cluster 308 to the fourth vehicle 114d. Since the vehicle capacity of the fourth vehicle 114d is four, the routing engine 210 determines that after mapping the two commutation requests of the second cluster 308to the fourth vehicle 114d, the fourth vehicle 114d has two vacant seats. Thus, the routing engine 210 further selects the fourth cluster 312 and maps the one remaining commutation request of the fourth cluster 312 to the fourth vehicle 114d. After mapping the one commutation request of the fourth cluster 312 to the fourth vehicle 114d, the routing engine 210 determines that all clusters of the second set of clusters 406 are catered to. Thus, the routing engine 210 determines the second route R2 for the fourth vehicle 114d. The second route R2 starts from the second cluster 308 and terminates at the drop-off location 602. The second route R2 further includes the fourth cluster 312 as an intermediate stop. In other words, the fourth vehicle 114d caters to the second and fourth clusters 308 and 312 of the second route R2. The routing engine 210 determines the first route combination RC1, as shown in Table 1 below, by including the first and second routes R1 and R2:

TABLE 1
First and second routes R1 and R2
of the first route combination RC1

| First route R1 | Second route R2 |
|---|---|
| C5 | C2 |
| C1 | C4 |
| C2 | D |
| D | |

Similarly, the routing engine 210 determines a second route combination RC2 by performing the method of FIGS. 5A and 5B. For determining the second route combination RC2 the routing engine 210 selects the second cluster 308 and the third vehicle 114c initially. Table 2 as shown below represents the second route combination RC2 including third and fourth routes R3 and R4:

TABLE 2
Third and fourth routes R3 and R4
of the second route combination RC2

| Third route R3 | Fourth route R4 |
|---|---|
| C2 | C4 |
| C1 | C1 |
| D | C5 |
| | D |

The routing engine 210 determines the plurality of route combinations including at least the first and second route combinations RC1 and RC2. The processor 202 in conjunction with the fitness-score calculator 214 further processes the plurality of route combinations to implement a genetic algorithm for selecting the optimum route combination from the plurality of route combinations. The plurality of route combinations serve as a first generation of route combinations for the genetic algorithm.

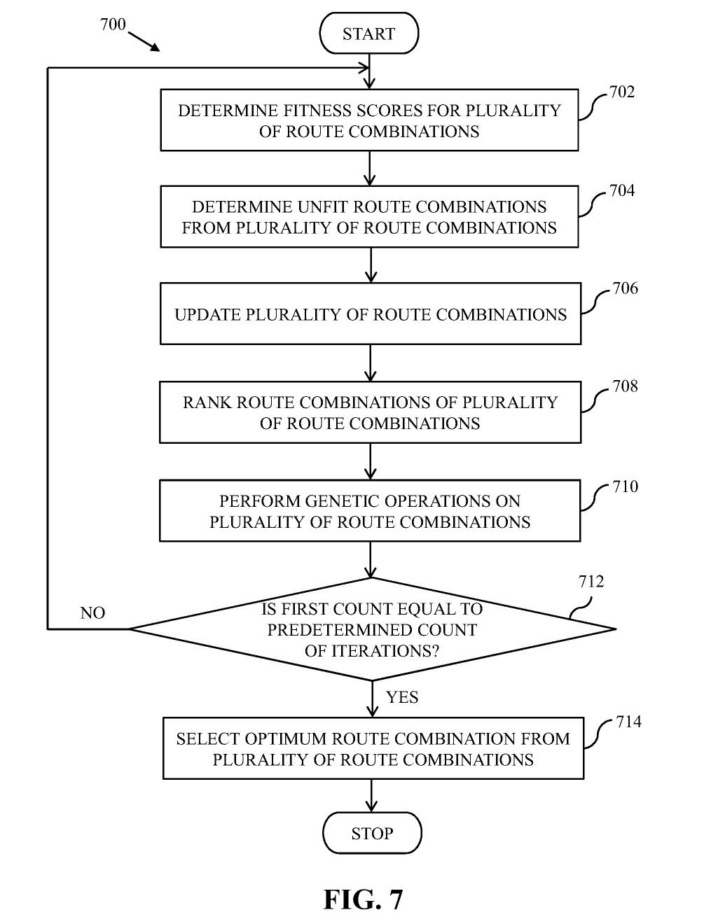

It will be apparent to a person skilled in the art that the abovementioned first and second route combinations RC1 and RC2 are for illustrative purpose and should not be construed to limit the scope of the invention. In another embodiment, a count of routes in each route combination of the plurality of route combinations may be different. The selection of the optimum route combination is explained in detail in conjunction with FIG. 7.

Referring now to FIG. 7, a flow chart 700 that illustrates a method for selecting the optimum route combination from the plurality of route combinations, in accordance with an embodiment of the present invention, is shown. At step 702, the fitness-score calculator 214 determines a fitness-score for each route combination of the first generation of route combinations. The fitness-score calculator 214 determines the fitness-score based on fitness parameters. The fitness parameters include distance and time fitness parameters.

Based on the distance fitness parameter, the fitness-score calculator 214 determines the fitness-score of a route combination by determining a sum of distances of the routes included in the route combination. For example, the fitness-score of the first route combination RC1 is based on the sum of distances of the first and second routes R1 and R2. Similarly, the fitness-score of the second route combination RC2 is based on the sum of distances of the third and fourth routes R3 and R4. In one embodiment, the first route combination RC1 may have a low fitness-score as compared to the second route combination RC2, when the sum of distances of the routes of the first route combination RC1 is greater than the sum of distances of the routes of the second route combination RC2.

Based on the time fitness parameter, the fitness-score calculator 214 determines the fitness-score of a route combination by determining a sum of travel durations associated with the routes of the route combination. For example, the fitness-score of the first route combination RC1 is based on the sum of travel duration associated with the first and second routes R1 and R2. Similarly, the fitness-score of the second route combination RC2 is based on the sum of travel duration associated with the third and fourth routes R3 and R4. For determining the fitness-score, the travel-time predictor 212 predicts the travel duration associated with each route included in the first generation of route combinations. The travel-time predictor 212 may utilize real-time traffic data and historical traffic data to predict the travel duration. Based on the travel duration predicted by the travel-time predictor 212, the fitness-score calculator 214 determines the fitness-score for each route combination of the first generation of route combinations. In one embodiment, the first route combination RC1 may have a low fitness-score as compared to the second route combination RC2, when the sum of the travel duration associated with the routes of the first route combination RC1 is greater than the travel duration associated with the routes of the second route combination RC2. In one embodiment, the fitness-score calculator 214 may determine the fitness-score for each route combination of the first generation of route combinations based on a weighted sum of the distance and time fitness parameters. It will be apparent to a person skilled in the art that the fitness-score may be calculated based on any other fitness parameter such as predicted traffic on all routes of a route combination and preferences of the transportation service provider without departing from the spirit of the invention. Further, the fitness-score for each route combination may vary at different times of a day as the traffic along the routes is dynamically changing resulting in variation in the predicted travel durations.

At step 704, the processor 202 identifies a set of unfit route combinations from the first generation of route combinations based on the one or more constraints. In one embodiment, the one or more constraints are specified by the transportation service provider. The one or more constraints include the distance constraint and the travel-time constraint. The distance constraint limits a maximum distance of a route included in a route combination. The travel-time constraint limits maximum travel duration for travelling along a route of a route combination. The comparator 216 thus compares the distance and travel durations of all the routes included in the first generation of route combinations with the distance and travel-time constraints, respectively. Based on the comparison, the comparator 216 identifies the route combinations, from the first generation of route combinations, which have routes violating the one or more constraints. In one example, the distance constraint is 4 kms and the travel-time constraint is 45 minutes. The first route R1 may have a distance of 3.5 kms and travel duration of 30 minutes, and the second route R2 may have a distance of 4.5 kms and travel duration of 30 minutes. Based on the comparison performed by the comparator 216, the processor 202 determines that distance (i.e., 4.5 kms) of the second route R2 violates the distance constraint (i.e., 4 kms). Thus, the processor 202 identifies the first route combination RC1 as an unfit route combination. In another example, the first route R1 may have a distance of 3.5 kms and travel duration of 40 minutes, and the second route R2 may have a distance of 3 kms and travel duration of 30 minutes. Based on the comparison performed by the comparator 216, the processor 202 determines that travel duration (i.e., 40 minutes) of the first route R1 violates the travel-time constraint (i.e., 4 kms). Thus, the processor 202 identifies the first route combination RC1 as an unfit route combination. In yet another example, the first route R1 may have a distance of 3.5 kms and travel duration of 25 minutes, and the second route R2 may have a distance of 3 kms and travel duration of 30 minutes. Based on the comparison performed by the comparator 216, the processor 202 determines both the first and second routes R1 and R2 do not violate the distance and travel-time constraints. Thus, the processor 202 does not identify any route combination as an unfit route combination.

At step 706, the processor 202 updates the first generation of route combinations based on the set of unfit route combinations. For updating the first generation of route combinations, the processor 202 discards the set of unfit route combinations from the first generation of route combinations.

At step 708, the processor 202, in conjunction with the comparator 216, ranks the route combinations of the first generation of route combinations. The comparator 216 compares the fitness-scores of every route combination with the fitness-scores of all other route combinations in the first generation of route combinations. Based on the comparison among the fitness-scores, the route combinations having higher fitness-scores are ranked higher as compared to the route combinations having a lower fitness-score by the processor 202.

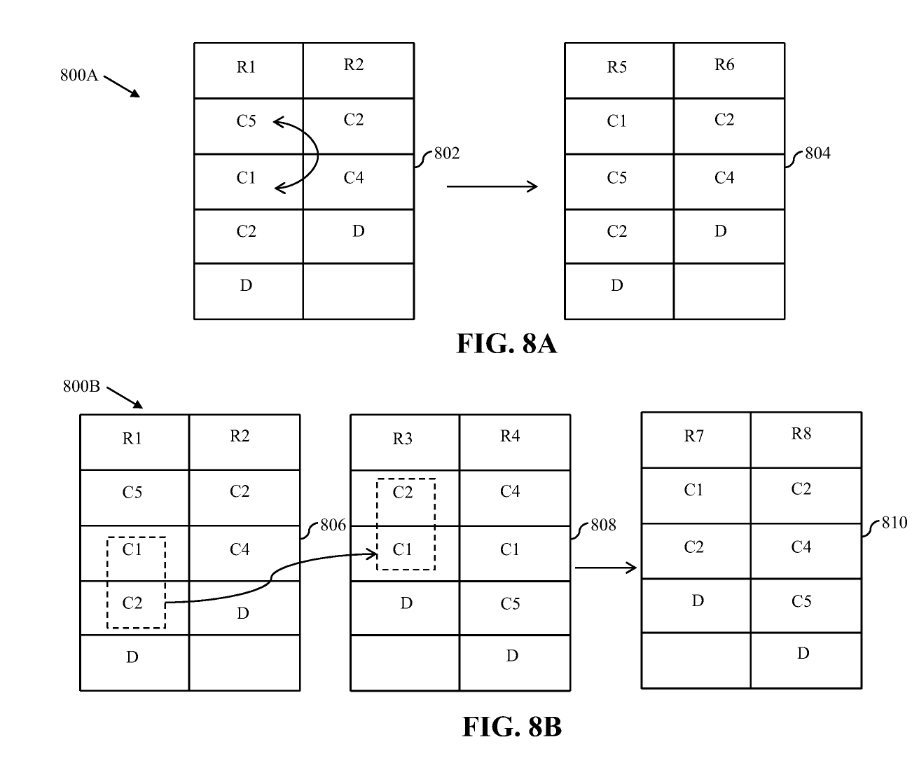

At step 710, the processor 202 performs genetic operations, such as selection, mutation, and crossover operations, on one or more route combinations of the first generation of route combinations for determining a second generation of route combinations. In other words, the processor 202 updates the first generation of route combinations by performing the genetic operations. In one embodiment, the genetic operations update one or more routes of the first generation of route combinations. For performing the selection operation, the processor 202 selects a predetermined percentage of route combinations from the first generation of route combinations, based on the fitness-score. In one example, the predetermined percentage is fifty percent. Thus, the processor 202 selects fifty percent of route combinations, from the first generation of route combinations, which have the highest ranks. In one embodiment, the route combinations that are selected based on the predetermined percentage constitute the second generation of route combinations. The mutation and crossover operations are explained in detail in conjunction with FIGS. 8A and 8B. The processor 202 may execute a predetermined count of iterations of performing the genetic operations. In one embodiment, the transportation service provider may specify the predetermined count of iterations. The processor 202 increments a first count, which has an initial value ‘0’, after performing every iteration.

At step 712, the processor 202 determines whether the first count is equal to the predetermined count of iterations. If at step 712, it is determined that the first count is not equal to the predetermined count of iterations, step 702 is performed. If at step 712, it is determined that the first count is equal to the predetermined count of iterations, step 714 is performed. A generation of route combinations, determined by the processor 202 when the first count is equal to the predetermined count of iterations, represents a final generation of route combinations.

At step 714, the processor 202 selects the optimum route combination from the final generation of route combinations based on the fitness-score. For example, the processor 202 selects the route combination, from the final generation of route combinations, having the highest rank as the optimum route combination. In other words, the processor 202 selects the route combination having the highest fitness-score as the optimum route combination.

In one embodiment, the processor 202 may not perform the genetic operations. In such a scenario, the first generation of route combinations is the final generation of route combinations, and the optimum route combination is selected from the first generation of route combinations.

Referring now to FIGS. 8A and 8B, exemplary scenarios 800A and 800B that illustrate mutation and crossover operations, respectively, in accordance with an embodiment of the present invention, are shown.

With reference to FIG. 8A, the exemplary scenario 800A depicts the first route combination RC1 as Table 802. The processor 202 performs the mutation operation on the first route combination RC1. For performing the mutation operation on the first route combination RC1, the processor 202 modifies the first route R1 (as shown in FIG. 4) by altering a sequence of clusters of the first route R1 randomly to generate a fifth route R5. For example, the first route R1 starts from the fifth cluster 314 (i.e., C5) and terminates at the drop-off location 602 (i.e., D) with the first and second clusters 306 and 308 as the intermediate stops. The fifth route R5 starts from the first cluster 306 (i.e., C1) and terminates at the drop-off location 602 (i.e., D) with the fifth and second clusters 314 and 308 as the intermediate stops. The first and fifth routes R1 and R5 cater to the same clusters, (i.e., the first, second, and fifth clusters 306, 308, and 314), however the sequence of clusters in the first and fifth routes R1 and R5 is different. The processor 202 further forms a third route combination RC3 by including the fifth route R5 and the second route R2 as a sixth route R6. The third route combination RC3 is depicted as Table 804 in the exemplary scenario 800A.

With reference to FIG. 8B, the exemplary scenario 800B depicts the first and second route combinations RC1 and RC2 as Tables 806 and 808, respectively. The processor 202 performs the crossover operation between the first and second route combinations RC1 and RC2. For performing the crossover operation between the first and second route combinations RC1 and RC2, the processor 202 modifies a portion of one or more routes of the second route combination RC2 based on one or more routes of the first route combination RC1 and generates a fourth route combination RC4. In other words, the processor 202 modifies the portion of the one or more routes of the second route combination RC2 to resemble the one or more routes of the first route combination RC1 and generates new routes. As shown in the exemplary scenario 800B, the processor 202 modifies the sequence of the first and second clusters 306 and 308 in the third route R3 to resemble the sequence of the first and second clusters 306 and 308 in the first route R1, and generates a seventh route R7. The processor 202 further generates an eighth route R8. In one embodiment, the processor 202 performs the crossover operation based on at least a travel duration associated with the one or more routes of the route combinations. For example, the travel-time predictor 212 determines that the travel duration for travelling from the first cluster 306 to the second cluster 308 is less than the travel duration for travelling from the second cluster 308 to the first cluster 306. Thus, the processor 202 modifies the sequence of the first and second clusters 306 and 308 in the third route R3 to resemble the sequence of the first and second clusters 306 and 308 in the first route R1, which has less travel duration. The processor 202 further forms the fourth route combination RC4 by including the seventh and eighth routes R7 and R8. The fourth route combination RC4 is depicted as Table 810 in the exemplary scenario 800B.

It will be apparent to a person skilled in the art that the abovementioned exemplary scenario 800A and 800B are for illustrative purpose and should not be construed to limit the scope of the invention. The processor 202 may perform the mutation and crossover operations on any number of the route combinations.

In one embodiment, the processor 202 updates the first generation of route combinations to include the new route combinations (such as the third and fourth route combinations RC3 and RC4) and forms the second generation of route combinations. For example, if the first generation of route combinations includes the first and second route combinations RC1 and RC2, the second generation of route combinations includes the first through fourth route combinations RC1-RC4. In another embodiment, the processor 202 replaces one or more route combinations of the first generation of route combinations with the new route combinations and forms the second generation of route combinations. For example, the processor 202 may replace the first and second route combinations RC1 and RC2 of the first generation of route combinations with the third and fourth route combinations RC3 and RC4 to form the second generation of route combinations.

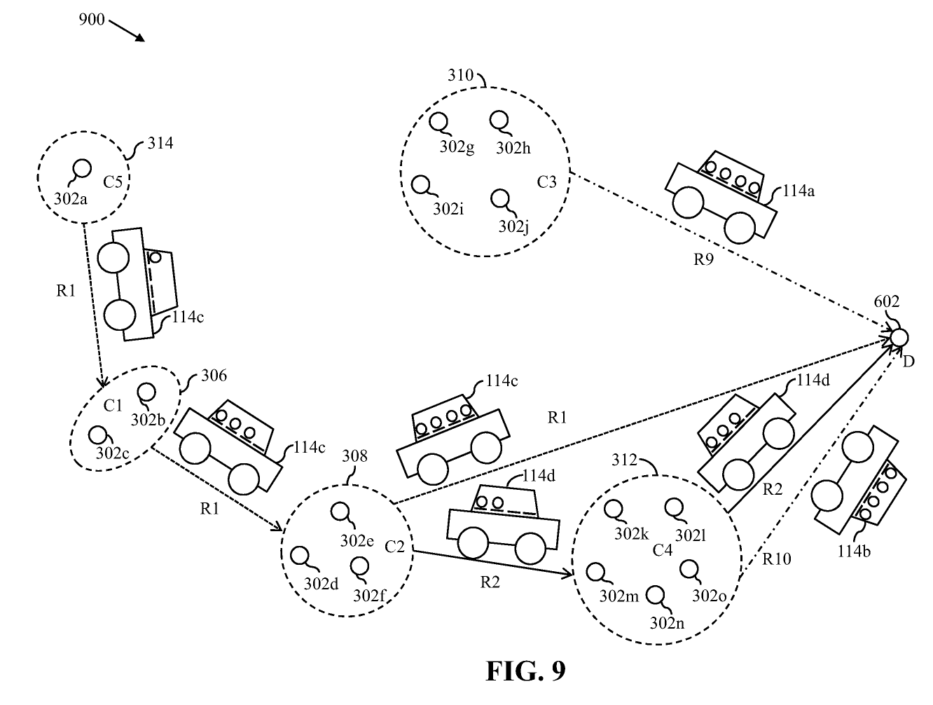

Referring now to FIG. 9, an exemplary scenario 900 that illustrates dispatching of the vehicles 114 along the first set of routes and the second set of routes of the optimum route combination, in accordance with an embodiment of the present invention, is shown.

The processor 202 determines the optimum route combination (for example, the first route combination RC1) including the first and second routes R1 and R2. The processor 202 further determines that the first set of routes includes ninth and tenth routes R9 and R10. The ninth and tenth routes R9 and R10 start from the third and fourth clusters 310 and 312, and terminate at the drop-off location 602 (i.e., D). The determination of the first set of routes is explained in the foregoing in FIG. 4. The processor 202 generates a route notification for each of the vehicles 114 to indicate a corresponding route to be travelled by each of the vehicles 114 to serve the commutation requests of the commuters 112. The transceiver 218 transmits the corresponding route notification to each of the vehicle-computing devices 110 over the communication network 106. Based on the route notification, the vehicles 114 are dispatched along the corresponding route indicated by the route notification. The first set of vehicles 404 (of FIG. 4) thus travels along the first set of routes and the second set of vehicles 408 (of FIG. 4) travels along the second set of routes.

As shown in the exemplary scenario 900, based on the route notification the first vehicle 114a is dispatched along the ninth route R9. The first vehicle 114a picks-up four commuters from the third cluster 310 and drops them at the drop-off location 602 (i.e., D) by travelling along the ninth route R9. Similarly, based on the route notification the second vehicle 114b is dispatched along the tenth route R10. The second vehicle 114b picks-up four commuters from the fourth cluster 312 and drops them at the drop-off location 602 (i.e., D) by travelling along the tenth route R10. Based on the route notification the third vehicle 114c is dispatched along the first route R1. The third vehicle 114c picks-up one commuter from the fifth cluster 314, two commuters from the first cluster 306, and one commuter from the second cluster 308, and drops them at the drop-off location 602 (i.e., D) by travelling along the first route R1. Based on the route notification the fourth vehicle 114d is dispatched along the second route R2. The fourth vehicle 114d picks-up the remaining two commuters from the second cluster 308 and the remaining one commuter from the fourth cluster 312, and drops them at the drop-off location 602 (i.e., D) by travelling along the second route R2. In other words, each of the vehicles 114 travels along the corresponding route to serve the corresponding commutation requests.

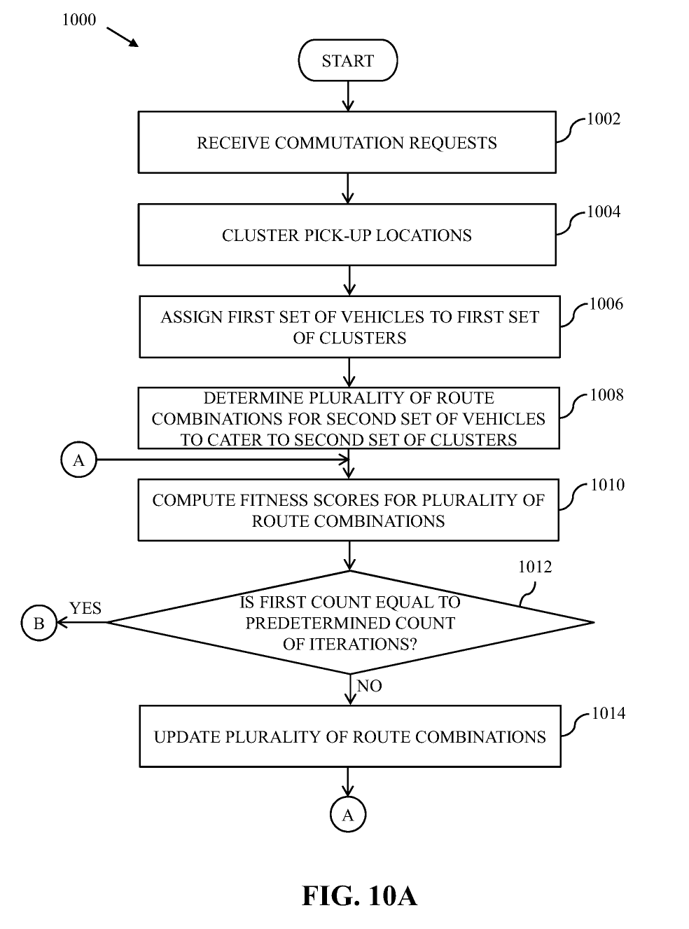

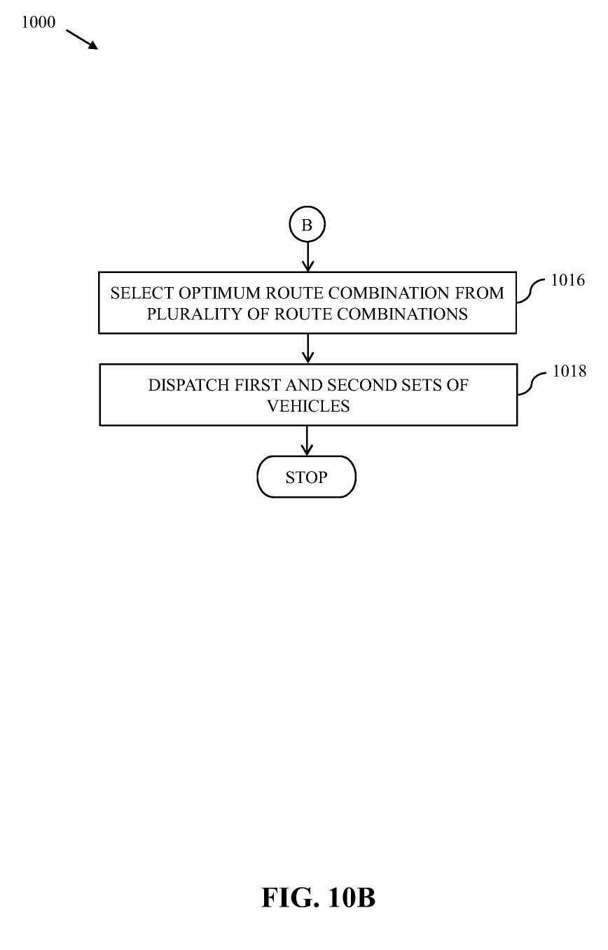

Referring now to FIGS. 10A and 10B, a flow chart 1000 that illustrates a method for determining routes for vehicles, in accordance with an embodiment of the present invention, is shown. At step 1002, the transportation server 104 receives the commutation requests associated with the pick-up locations, such as the first through fifteenth pick-up locations 302a-302o. At step 1004, the transportation server 104 clusters the pick-up locations into the clusters, such as the clusters 306-314, based on the clustering parameters.

At step 1006, the transportation server 104 assigns the first set of vehicles 404 to the first set of clusters 402 (as described in FIG. 4). At step 1008, the transportation server 104 determines the plurality of route combinations for the second set of vehicles 408 to cater to the second set of clusters 406 (as described in FIGS. 4, 5A and 5B, and 6). At step 1010, the transportation server 104 determines the fitness-scores of each of the plurality of route combinations based on the fitness parameters (as described in FIG. 7). At step 1012, the transportation server 104 determines whether the first count is equal to the predetermined count of iterations (as described in FIG. 7). If at step 1012, the transportation server 104 determines that the first count is not equal to the predetermined count of iterations, step 1014 is performed.

At step 1014, the transportation server 104 updates one or more of the plurality of route combinations (as described in FIGS. 7, 8A and 8B) and then step 1010 is performed. If at step 1012, the transportation server 104 determines that the first count is equal to the predetermined count of iterations, step 1016 is performed. At step 1016, the transportation server 104 selects the optimum route combination from the plurality of route combinations based on the fitness-scores of each of the plurality of route combinations (as described in FIG. 7). At step 1018, the transportation server 104 dispatches the first and second sets of vehicles 404 and 408 to serve the commutation requests, and the process ends.

In one embodiment, the transportation server 104 may repeat the method illustrated by the flow chart 1000 after a predetermined time interval. The predetermined time interval may be specified by the transportation service provider. In one embodiment, the transportation server 104 may implement the method illustrated by the flow chart 1000 for serving real-time commutation requests.

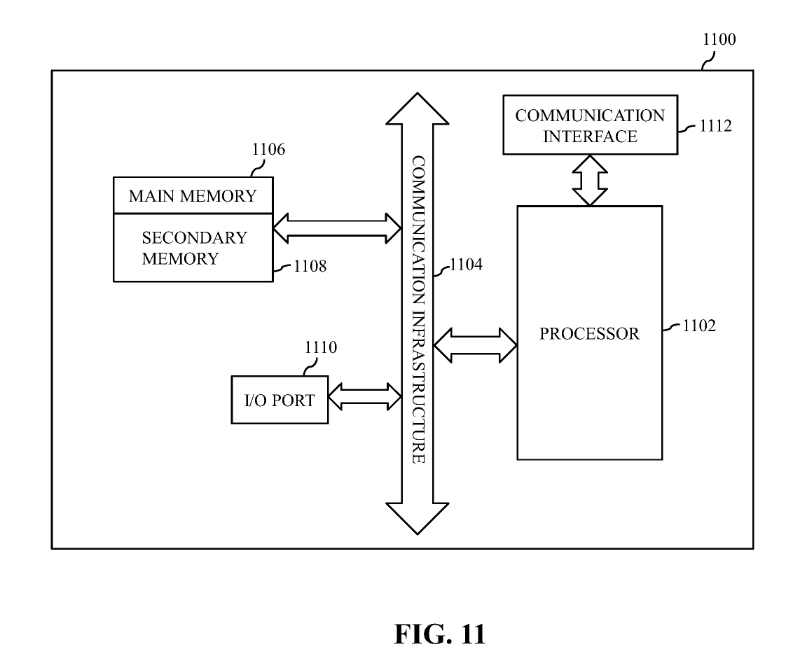

Referring now to FIG. 11 a block diagram of a computer system 1100 for determining routes for vehicles in the environment of FIG. 1 in accordance with an embodiment of the present invention is shown. An embodiment of present invention, or portions thereof, may be implemented as computer readable code on the computer system 1100. In one example, the database server 102, the plurality of commuter-computing devices 108, and the plurality of vehicle-computing devices 110 of FIG. 1 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIGS. 10A and 10B.

The computer system 1100 includes a processor 1102 that may be a special purpose or a general purpose processing device. The processor 1102 may be a single processor, multiple processors, or combinations thereof. The processor 1102 may have one or more processor “cores.” Further, the processor 1102 may be connected to a communication infrastructure 1104, such as a bus, a bridge, a message queue, the communication network 106, multi-core message-passing scheme, and the like. The computer system 1100 further includes a main memory 1106 and a secondary memory 1108. Examples of the main memory 1106 may include random access memory (RAM), read-only memory (ROM), and the like. The secondary memory 1108 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 1100 further includes an input/output (I/O) port 1110 and a communication interface 1112. The I/O port 1110 includes various input and output devices that are configured to communicate with the processor 1102. Examples of the input devices may include a keyboard, a mouse, a joystick, a touchscreen, a microphone, and the like. Examples of the output devices may include a display screen, a speaker, headphones, and the like. The communication interface 1112 may be configured to allow data to be transferred between the computer system 1100 and various devices that are communicatively coupled to the computer system 1100. Examples of the communication interface 1112 may include a modem, a network interface, i.e., an Ethernet card, a communications port, and the like. Data transferred via the communication interface 1112 may correspond to signals, such as electronic, electromagnetic, optical, or other signals as will be apparent to a person skilled in the art. The signals may travel via a communications channel, which may be configured to transmit the signals to devices that are communicatively coupled to the computer system 1100. Examples of the communication channel may include, but are not limited to, cable, fiber optics, a phone line, a cellular phone link, a radio frequency link, a wireless link, and the like.

Computer program medium and computer usable medium may refer to memories, such as the main memory 1106 and the secondary memory 1108, which may be a semiconductor memory such as dynamic RAMs. These computer program mediums may provide data that enables the computer system 1100 to implement the method illustrated in FIGS. 10A and 10B. In an embodiment, the present invention is implemented using a computer implemented application, such as the service application of the plurality of commuter-computing devices 108. The computer implemented application may be stored in a computer program product and loaded into the computer system 1100 using the removable storage drive or the hard disc drive in the secondary memory 1108, the I/O port 1110, or the communication interface 1112.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 1102 and a memory such as the main memory 1106 and the secondary memory 1108 implements the above described embodiments. Further, the operations may be described as a sequential process; however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

The selection of the optimum route combination from the plurality of route combinations leads to an efficient utilization of the vehicles 114. The transportation service provider can set the one or more clustering parameters and the one or more constraints according to business requirements. Additionally, the one or more clustering parameters can be adjusted as required based on a count of commutation requests raised. For example, the transportation service provider can set the distance threshold parameter as a small distance to obtain dense clusters during a period of high demand for transportation services whereas as the distance threshold parameter can be set to a large distance to obtain sparse clusters during a period of low demand for transportation services. Hence, the method 1000 offers a dynamically adaptable solution to optimize the transportation services that takes into consideration the one or more constraints set by the transportation service providers. Further the processing time for the method 1000 can be adjusted by modifying the predetermined count of iterations. Thus, the method 1000 can be implemented for serving real-time commutation requests.

Techniques consistent with the present invention provide, among other features, a method and system for determining transportation service routes for vehicles. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for determining transportation service routes for vehicles, the method comprising:
clustering, by circuitry, a plurality of pick-up locations of a plurality of commuters into a plurality of clusters, based on one or more clustering parameters, wherein each cluster of the plurality of clusters includes one or more pick-up locations of the plurality of pick-up locations, and wherein each cluster has a corresponding cluster size;
determining, by the circuitry, a plurality of route combinations for a first set of vehicles of a plurality of vehicles to cater to a first set of clusters of the plurality of clusters, based on at least a vehicle capacity of each of the first set of vehicles and the cluster size of each of the first set of clusters, wherein each route combination of the plurality of route combinations includes a first set of transportation service routes, and wherein the first set of transportation service routes caters to the first set of clusters and terminate at a drop-off location;
determining, by the circuitry, a fitness-score for each of the plurality of route combinations based on one or more fitness parameters; and
selecting, by the circuitry, an optimum route combination from the plurality of route combinations based on the fitness-score, wherein the first set of vehicles is dispatched along the first set of transportation service routes of the optimum route combination to pick-up a first set of commuters of the plurality of commuters, and wherein the first set of commuters is associated with the first set of clusters.

2. The method of claim 1, further comprising receiving, by the circuitry, a plurality of commutation requests from a plurality of commuter-computing devices of the plurality of commuters, respectively, wherein the plurality of commutation requests include the plurality of pick-up locations of the plurality of commuters, respectively, and the drop-off location.

3. The method of claim 1, further comprising receiving, by the circuitry, a plurality of commutation requests of the plurality of commuters from a database server, wherein the plurality of commutation requests include the plurality of pick-up locations of the plurality of commuters, respectively, and the drop-off location.

4. The method of claim 1, wherein a clustering parameter of the one or more clustering parameters is a distance threshold parameter, and wherein first and second pick-up locations of the plurality of pick-up locations are clustered into a first cluster of the plurality of clusters, when a distance between the first and second pick-up locations is less than or equal to the distance threshold parameter.

5. The method of claim 1, wherein a clustering parameter of the one or more clustering parameters is a travel-time threshold parameter, and wherein first and second pick-up locations of the plurality of pick-up locations are clustered into a first cluster of the plurality of clusters, when a travel duration between the first and second pick-up locations is less than or equal to the travel-time threshold parameter.

6. The method of claim 1, further comprising assigning, by the circuitry, a second set of vehicles of the plurality of vehicles to a second set of clusters of the plurality of clusters, based on at least a vehicle capacity of each of the second set of vehicles and the cluster size of each of the second set of clusters, wherein a first vehicle of the second set of vehicles is assigned to a first cluster of the second set of clusters, when a vehicle capacity of the first vehicle is less than or equal to the cluster size of the first cluster.

7. The method of claim 6, wherein the first set of clusters includes remaining clusters of the plurality of clusters that are unassigned to the second set of vehicles and a subset of the second set of clusters having the cluster size greater than the vehicle capacity of the corresponding assigned vehicle of the second set of vehicles.

8. The method of claim 6, wherein the second set of vehicles is dispatched along a second set of transportation service routes that caters to the second set of clusters, and wherein each transportation service route of the second set of transportation service routes terminates at the drop-off location.

9. The method of claim 1, wherein a fitness parameter of the one or more fitness parameters is a distance fitness parameter, and wherein the fitness-score of each route combination of the plurality of route combinations is a sum of distances of the first set of transportation service routes of the corresponding route combination.

10. The method of claim 1, wherein a fitness parameter of the one or more fitness parameters is a time fitness parameter, and wherein the fitness-score of each route combination of the plurality of route combinations is a travel duration associated with the first set of transportation service routes of the corresponding route combination.

11. The method of claim 1, further comprising updating, by the circuitry, one or more route combinations of the plurality of route combinations, based on a modification of the first set of transportation service routes of each of the one or more route combinations.

12. A system for determining transportation service routes for vehicles, the system comprising:
circuitry that is configured to:
cluster a plurality of pick-up locations of a plurality of commuters into a plurality of clusters based on one or more clustering parameters, wherein each cluster of the plurality of clusters includes one or more pick-up locations of the plurality of pick-up locations, and wherein each cluster has a corresponding cluster size;
determine a plurality of route combinations for a first set of vehicles of a plurality of vehicles to cater to a first set of clusters of the plurality of clusters, based on at least a vehicle capacity of each of the first set of vehicles and the cluster size of each of the first set of clusters, wherein each route combination of the plurality of route combinations includes a first set of transportation service routes, and wherein the first set of transportation service routes caters to the first set of clusters and terminate at a drop-off location;
determine a fitness-score for each of the plurality of route combinations based on one or more fitness parameters; and
select an optimum route combination from the plurality of route combinations based on the fitness-score, wherein the first set of vehicles is dispatched along the first set of transportation service routes of the optimum route combination to pick-up a first set of commuters of the plurality of commuters, and wherein the first set of commuters is associated with the first set of clusters.

13. The system of claim 12, wherein the circuitry is further configured to receive a plurality of commutation requests from a plurality of commuter-computing devices of the plurality of commuters, respectively, and wherein the plurality of commutation requests include the plurality of pick-up locations of the plurality of commuters, respectively, and the drop-off location.

14. The system of claim 12, wherein the circuitry is further configured to receive a plurality of commutation requests of the plurality of commuters from a database server, and wherein the plurality of commutation requests include the plurality of pick-up locations of the plurality of commuters, respectively, and the drop-off location.

15. The system of claim 12, wherein the one or more clustering parameters include:
a distance threshold parameter, wherein first and second pick-up locations of the plurality of pick-up locations are clustered into a first cluster of the plurality of clusters, when a distance between the first and second pick-up locations is less than or equal to the distance threshold parameter; and
a travel-time threshold parameter, wherein the first and second pick-up locations of the plurality of pick-up locations are clustered into the first cluster of the plurality of clusters, when a travel duration between the first and second pick-up locations is less than or equal to the travel-time threshold parameter.

16. The system of claim 12, wherein the circuitry is further configured to assign a second set of vehicles of the plurality of vehicles to a second set of clusters of the plurality of clusters, based on at least a vehicle capacity of each of the second set of vehicles and the cluster size of each of the second set of clusters, and wherein a first vehicle of the second set of vehicles is assigned to a first cluster of the second set of clusters, when a vehicle capacity of the first vehicle is less than or equal to the cluster size of the first cluster.

17. The system of claim 16, wherein the first set of clusters includes remaining clusters of the plurality of clusters that are unassigned to the second set of vehicles and a subset of the second set of clusters having the cluster size greater than the vehicle capacity of the corresponding assigned vehicle of the second set of vehicles.

18. The system of claim 16, wherein the second set of vehicles is dispatched along a second set of transportation service routes that caters to the second set of clusters, and wherein each transportation service route of the second set of transportation service routes terminates at the drop-off location.

19. The system of claim 12, wherein the one or more fitness parameters include:
a distance fitness parameter, wherein the fitness-score of each route combination of the plurality of route combinations is based on at least a sum of distances of the first set of transportation service routes of the corresponding route combination; and
a time fitness parameter, wherein the fitness-score of each route combination of the plurality of route combinations is based on at least a travel duration associated with the first set of transportation service routes of the corresponding route combination.

20. The system of claim 12, wherein the circuitry is further configured to update one or more route combinations of the plurality of route combinations, based on a modification of the first set of transportation service routes of each of the one or more route combinations.
